(19) United States
(12) Patent Application Publication
(10) Pub. No.: US 2026/0304429 A1
(43) Pub. Date: Oct. 1, 2026

(54) NESTED SEQUENCE INDEXING FOR UPLINK CONTROL INFORMATION

(71) Applicant: QUALCOMM Incorporated, San Diego, CA (US)

(72) Inventors: Mostafa KHOSHNEVISAN, San Diego, CA (US); Tao LUO, San Diego, CA (US); Xiaoxia ZHANG, San Diego, CA (US); Junyi LI, Greentown, PA (US); Sony AKKARAKARAN, Poway, CA (US)

(21) Appl. No.: 19/093,113

(22) Filed: Mar. 27, 2025

(51) Int. Cl. H04W 72/21; H04L 1/1812; H04L 27/26

(52) U.S. Cl. CPC H04W 72/21; H04L 1/1812; H04L 27/2605

(57) ABSTRACT

A method for wireless communication by a user equipment (UE) includes encoding a first sequence of k+1 bits of first uplink control information (UCI) using a sequence index that is in accordance with a value of a final (k+1)^{th} bit of the first sequence of k+1 bits of the first UCI, the sequence index being: a first sequence index, that is associated with encoding a first k bits of the first sequence of k+1 bits of the first UCI, in accordance with the final (k+1)^{th} bit of the UCI having a first value, or a second sequence index, that is not associated with encoding any sequence of k bits of UCI, in accordance with the final (k+1)^{th} bit of the first UCI having a second value. The method also includes transmitting, to a network node, the encoded UCI.

### FIELD OF THE DISCLOSURE

The present disclosure relates generally to wireless communications, and more specifically to nested sequence indexing for uplink control information (UCI) transmissions on a physical uplink control channel (PUCCH).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (for example, bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (for example, also known as discrete Fourier transform spread OFDM (DFT-s-OFDM)) on the uplink (UL), as well as supporting beamforming, multiple-input multiple-output (MIMO) antenna technology, and carrier aggregation.

In some wireless communication systems, a physical uplink control channel (PUCCH) is a dedicated uplink channel used to transmit control information, such as uplink control information (UCI), from the UE to a network node. In some cases, the UCI may include hybrid automatic repeat request (HARQ) feedback to acknowledge receipt of a downlink transmission, such as downlink control information (DCI). Sequence indices may map different UCI payloads to specific transmission sequences. Each sequence index determines a cyclic shift and/or orthogonal properties of the PUCCH transmission, such that multiple UEs can simultaneously transmit control information without interference.

### SUMMARY

In some aspects of the present disclosure, a method for wireless communication by a user equipment (UE) includes encoding a first sequence of k+1 bits of first uplink control information (UCI) using a sequence index that is in accordance with a value of a final (k+1)^{th} bit of the first sequence of k+1 bits of the first UCI. The sequence index is a first sequence index, that is associated with encoding a first k bits of the first sequence of k+1 bits of the first UCI, in accordance with the final (k+1)^{th} bit of the UCI having a first value, or a second sequence index, that is not associated with encoding any sequence of k bits of UCI, in accordance with the final (k+1)^{th} bit of the first UCI having a second value. The method also includes transmitting the encoded UCI to a network node.

Other aspects of the present disclosure are directed to an apparatus. The apparatus includes means for encoding a first sequence of k+1 bits of first UCI using a sequence index that is in accordance with a value of a final (k+1)^{th} bit of the first sequence of k+1 bits of the first UCI. The sequence index is a first sequence index, that is associated with encoding a first k bits of the first sequence of k+1 bits of the first UCI, in accordance with the final (k+1)^{th} bit of the UCI having a first value, or a second sequence index, that is not associated with encoding any sequence of k bits of UCI, in accordance with the final (k+1)^{th} bit of the first UCI having a second value. The apparatus further includes means for transmitting the encoded UCI to a network node.

In other aspects of the present disclosure, a non-transitory computer-readable medium with program code recorded thereon is disclosed. The program code is executed by one or more processors and includes program code to encode a first k bits of the first sequence of k+1 bits of the first UCI, in accordance with the final (k+1)^{th} bit of the UCI having a first value, or a second sequence index, that is not associated with encoding any sequence of k bits of UCI, in accordance with the final (k+1)^{th} bit of the first UCI having a second. The program code also includes program code to transmit the encoded UCI to a network node.

Other aspects of the present disclosure are directed to a UE. The apparatus includes one or more processors and one or more memories coupled with the one or more processors. The memory stores processor-executable code that, when executed by the one or more processors, causes the UE to encode a first k bits of the first sequence of k+1 bits of the first UCI, in accordance with the final (k+1)^{th} bit of the UCI having a first value, or a second sequence index, that is not associated with encoding any sequence of k bits of UCI, in accordance with the final (k+1)^{th} bit of the first UCI having a second. Execution of the processor-executable code further causes the UE to transmit the encoded UCI to a network node.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a block diagram illustrating an example of physical uplink control channel (PUCCH) sequence design with a nested property, in accordance with various aspects of the present disclosure.

FIG. 5 is a diagram illustrating an example of cyclic shift mapping, in accordance with various aspects of the present disclosure.

FIGS. 6A, 6B, and 6C are diagrams illustrating examples of non-uniform cyclic shift mapping, in accordance with various aspects of the present disclosure.

FIGS. 7A, 7B, and 7C illustrate examples of sequence mapping based on a cyclic shift value and a row or column index of a discrete Fourier transform (DFT) matrix, in accordance with various aspects of the present disclosure.

FIG. 8 is a block diagram illustrating an example wireless communication device that supports encoding uplink control information (UCI) in accordance with a nested sequence indexing framework, in accordance with various aspects of the present disclosure.

FIG. 9 is a flow diagram illustrating an example of a process for encoding UCI in accordance with a nested sequence indexing framework, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

In some wireless communication systems, a network node may transmit downlink control information (DCI) to schedule downlink data transmissions. The user equipment (UE) decodes the received DCI and generates uplink control information (UCI) in response to decoding the DCI. The UCI may include hybrid automatic repeat request (HARQ) feedback, channel state information (CSI), or scheduling requests (SRs), and is transmitted via a physical uplink control channel (PUCCH). A number of bits in the UCI may be a function of a number of successfully decoded DCI messages.

However, an issue arises when the UE fails to receive or decode all scheduled DCI messages, resulting in a mismatch between an expected UCI payload size and an actual UCI payload size. Specifically, if the UE fails to decode one or more DCI messages, the generates fewer UCI bits than anticipated by the network node. Existing mechanisms, such as the downlink assignment index (DAI), help manage missing DCI messages in the middle of a sequence by allowing the UE to infer their presence. The DAI acts as a counter, enabling the UE to detect missing messages. For instance, if the UE receives one DCI with a DAI value of one and another with a DAI value of four, the UE can deduce that two intermediate DCIs were lost and the UE inserts negative acknowledgements (NACKs) (for example, zero-bit values) to fill the missing feedback slots. However, the DAI mechanism is ineffective when a last scheduled DCI is missing, leading to incorrectly sized UCI transmissions that the network node cannot correctly interpret.

This mismatch is particularly problematic for PUCCH Format 0 and Format 1, which use sequence-based transmission rather than coded payloads. Unlike formats that use Reed-Muller (RM) coding for larger payloads (for example, 3 to 11 bits), where adding zero-padding does not affect decoding, sequence-based PUCCH formats map UCI payloads directly to cyclic shifts, making the PUCCH formats sensitive to mismatches. A risk in these cases is a NACK-to-ACK (N2A) error, where the network node mistakenly decodes a missing HARQ feedback bit as an acknowledgment (ACK) due to sequence mapping inconsistencies.

For example, a UE may be scheduled to receive two DCI messages, but only decodes the first DCI message. As a result, the UE generates a one-bit UCI payload instead of the expected two-bit payload. In PUCCH Format 0, a one-bit payload with a value of “1” is mapped to cyclic shift 6 based on a predefined mapping table. However, when the network node decodes cyclic shift 6, the network node expects a two-bit UCI payload and assumes the UE transmitted {1,1} (two ACKs), based on a predefined mapping table. Because the second DCI was never received, the second bit should have been a NACK, but the network instead interprets the second bit as an ACK, resulting in an incorrect HARQ feedback transmission.

To mitigate such NACK-to-ACK errors, some conventional solutions swap sequence mappings for specific payloads. In such cases, instead of interpreting cyclic shift 6 as {1,1}, the network assumes a value of {1,0}, ensuring that the missing bit is treated as a NACK. This swapping enables automatic zero-padding, allowing the network node to correct UCI payload mismatches without additional signaling or retransmissions. For example, if the UE transmits only one bit of UCI while the network expects two, the network can infer the missing bit as a NACK instead of incorrectly assuming the missing bit is an ACK.

However, while the swapping of sequence mappings reduces errors caused by UCI payload mismatches, this solution introduces a trade-off in PUCCH performance. Swapping sequence mappings can reduce the minimum Euclidean distance between adjacent sequences, making such sequences less distinguishable in noisy environments. In sequence-based PUCCH formats, Euclidean distance measures how well two sequences can be distinguished in the presence of noise or interference. A reduced Euclidean distance increases the risk of misclassification at the network node, leading to a higher probability of decoding errors. Consequently, while sequence swapping can address payload mismatches, swapping may also reduce the overall robustness of PUCCH transmission in scenarios where all DCI messages are successfully decoded.

Various aspects of the present disclosure address mismatches between an expected UCI payload size and an actual UCI payload size by providing a structured framework for maintaining continuity in sequence indexing between different UCI payload sizes. Specifically, various aspects of the present disclosure are directed to a nested sequence indexing framework that provides consistent sequence index mapping between different UCI payload sizes. The different UCI payload sizes may result from the UE failing to decode at least a final scheduled DCI message or multiple final scheduled DCI messages.

In some examples, the UE generates UCI comprising a sequence of k+1 bits. The UCI may be generated in accordance with the UE decoding a group of DCI messages transmitted by the network node. Additionally, the UCI may be encoded using a sequence index that is in accordance with a value of the final (k+1)^{th} bit of the sequence of k+1 bits of the UCI. The sequence of k+1 bits may be an example of a UCI payload. In some examples, the sequence index is a first sequence index, that is associated with encoding the first k bits of the sequence of bits of the UCI, in accordance with the final (k+1)^{th} bit of the UCI having a first value (for example, zero), ensuring that the sequence mapping remains consistent when extending from k bits to k+1 bits. Alternatively, second sequence index, that is not associated with encoding any sequence of k bits of UCI, in accordance with the final (k+1)^{th} bit of the UCI having a second value (for example, one), thereby preventing sequence overlap and ensuring differentiation when extending a length of the UCI.

In some implementations, each sequence index may map to a cyclic shift value, such that different sequences remain orthogonal in the frequency domain. To improve resource allocation, the cyclic shift spacing may be non-uniform. In such cases, respective sequence indices with minor bit differences are mapped to closely spaced cyclic shifts, while respective sequence indices with greater differences are mapped to cyclic shifts that are farther apart to improve decoding reliability.

In other implementations, the sequence index may map to a discrete Fourier transform (DFT) matrix, where the first sequence index is associated with a first row or column index of the DFT matrix, and the second sequence index is associated with a second row or column index of the DFT matrix. The mapping in accordance with a row or column index of the DFT matrix allows the network node to distinguish UCI payloads using DFT matrix indices such that different sequences remain orthogonal in time domain. In some examples, row or column index spacing in the DFT matrix may be non-uniform.

In other implementations, the sequence index mapping follows a structured approach where each first and second sequence index is determined based on a combination of a cyclic shift value and a row or column index. The combination of the cyclic shift value and the row or column index may be referred to as a sequence index pair. In such implementations, the UE maps a portion of UCI bits to a cyclic shift value and another portion to the row or column index. Additionally, in such implementations, the final (k+1)^{th} bit may be transmitted in accordance with a cyclic shift domain or a DFT domain based on whether the final bit is mapped to the cyclic shift value or the row or column index. If final (k+1)^{th} bit is transmitted in the cyclic shift domain, and has a first binary value (for example, zero), the UE selects the same sequence index pair as a k-bit UCI. If the final bit is one, the UE selects a new cyclic shift value while maintaining the same DFT matrix index. Conversely, if the final (k+1)^{th} bit is transmitted in the DFT domain, with a value of zero, the UE again selects the same sequence index pair as the k-bit UCI. If the final (k+1)^{th} bit is one, the UE selects a new DFT matrix index while maintaining the same cyclic shift value. This approach ensures that extended UCI payloads are mapped in a predictable manner, preventing sequence overlap and reducing decoding errors at the network.

Particular aspects of the subject matter described in this disclosure can be implemented to realize one or more of the following potential advantages. The described nested sequence indexing framework improves UCI transmission reliability by maintaining continuity in sequence mapping across different UCI payload sizes. Maintaining sequence index continuity between payloads of varying lengths, may mitigate unintended remapping of sequence indices, thereby, reducing decoding errors at the network node. Furthermore, maintaining sequence index continuity enables automatic zero-padding in cases where the UE transmits fewer bits in a UCI payload than expected, eliminating, or reducing, a need for additional signaling while mitigating NACK-to-ACK misinterpretations and avoiding unnecessary UCI retransmissions. Additionally, maintaining sequence index continuity may improve the Euclidean distance between adjacent sequence indices, preserving the robustness of PUCCH transmission even in the presence of noise or interference.

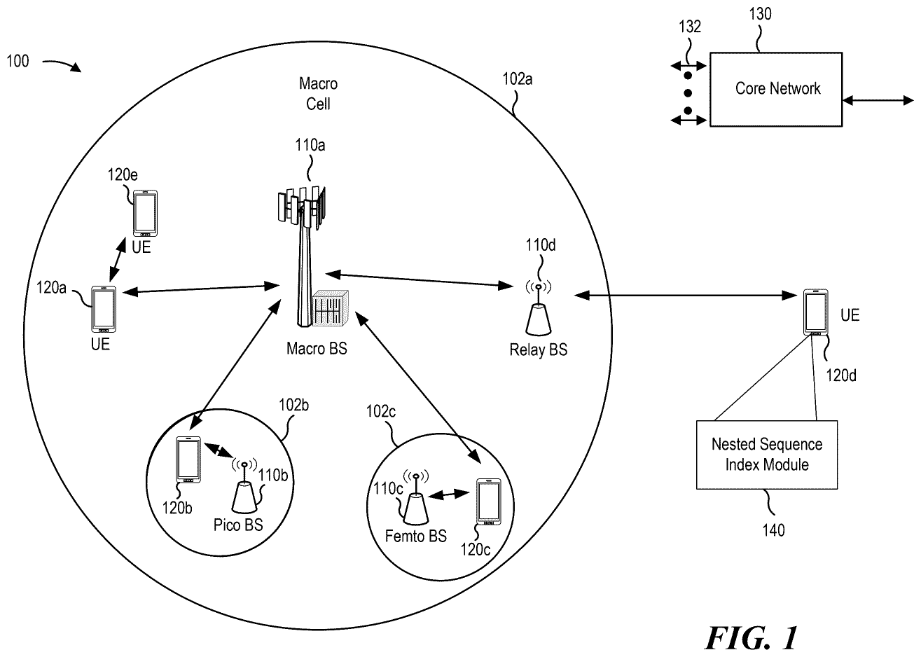

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example, three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (for example, macro BSs, pico BSs, femto BSs, relay BSs, and/or the like). These different types of BSs may have different transmit power levels, different coverage areas, and different impact on interference in the wireless network 100. For example, macro BSs may have a high transmit power level (for example, 5 to 40 watts) whereas pico BSs, femto BSs, and relay BSs may have lower transmit power levels (for example, 0.1 to 2 watts).

As an example, the BSs 110 (shown as BS 110a, BS 110b, BS 110c, and BS 110d) and the core network 130 may exchange communications via backhaul links 132 (for example, S1, etc.). Base stations 110 may communicate with one another over other backhaul links (for example, X2, etc.) either directly or indirectly (for example, through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (for example, S1, S2, etc.) and may perform radio configuration and scheduling for communications with the UEs 120. In some configurations, various functions of each access network entity or base station 110 may be distributed across various network devices (for example, radio heads and access network controllers) or consolidated into a single network device (for example, a base station 110).

UEs 120 (for example, 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

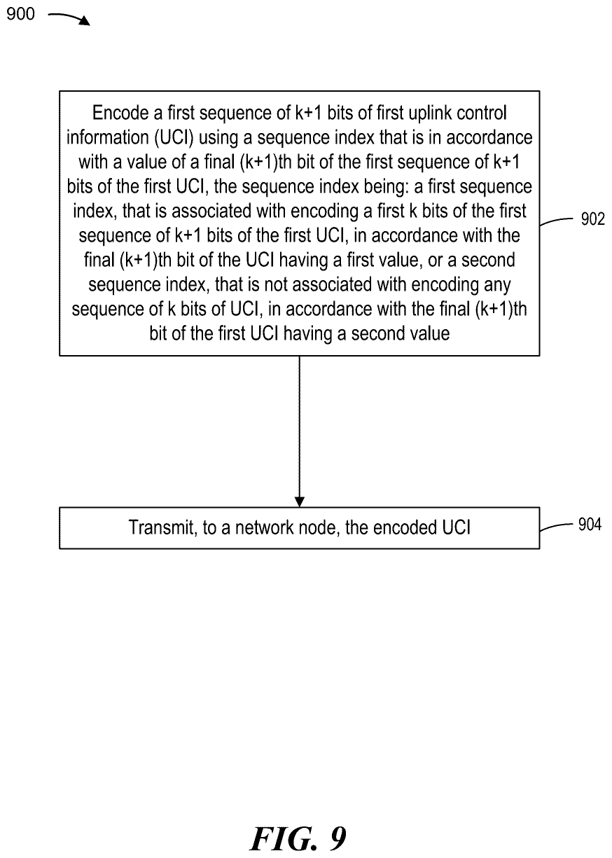

The UEs 120 may include a nested sequence index module 140. For brevity, only one UE 120d is shown as including the nested sequence index module 140. The nested sequence index module 140 may perform various functions, such as one or more functions of the process 900 described with reference to FIG. 9.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (for example, a system information block (SIB).

As indicated above, FIG. 1 is provided merely as an example. Other examples may differ from what is described with regard to FIG. 1.

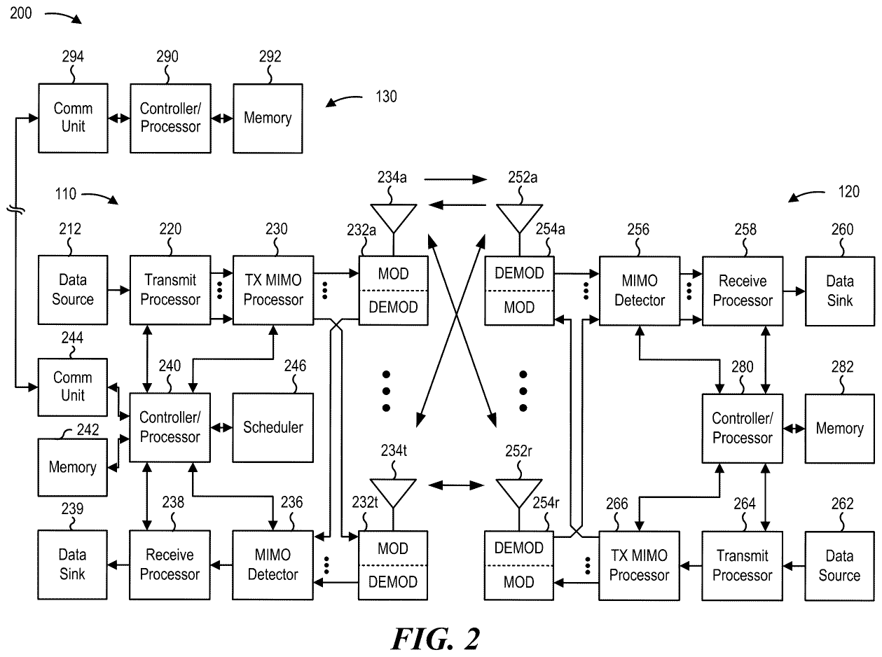

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example, for semi-static resource partitioning information (SRPI) and/or the like) and control information (for example, CQI requests, grants, upper layer signaling, and/or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example, for orthogonal frequency division multiplexing (OFDM) and/or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (for example, for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (for example, for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with nested sequence indexing as described in more detail elsewhere. For example, the controller/processor 240 of the base station 110, the controller/processor 280 of the UE 120, and/or any other component(s) of FIG. 2 may perform or direct operations of, for example, the process of FIG. 9 and/or other processes as described. Memories 242 and 282 may store data and program codes for the base station 110 and UE 120, respectively. A scheduler 246 may schedule UEs for data transmission on the downlink and/or uplink.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (for example, a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

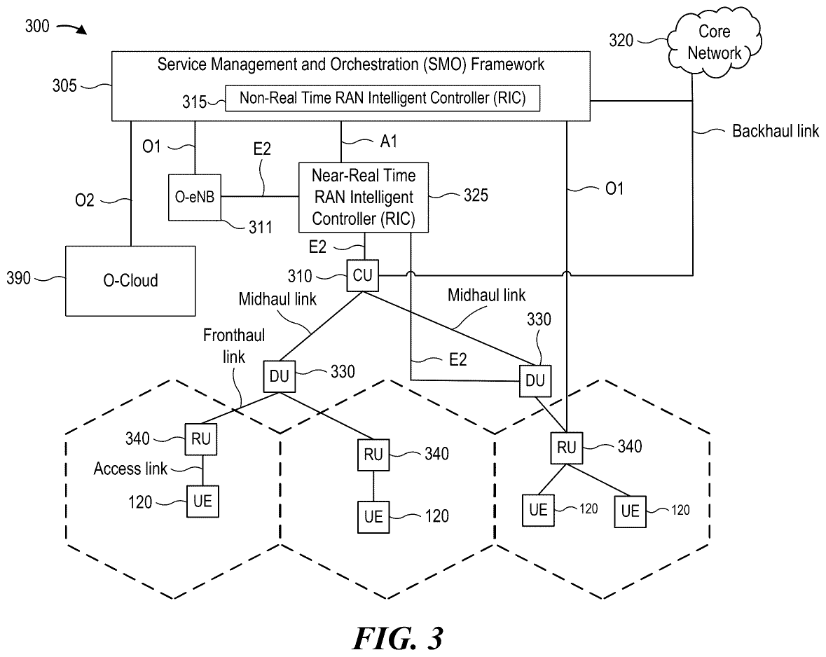

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (for example, the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (for example, central unit-user plane (CU-UP)), control plane functionality (for example, central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

As discussed, a problem may arise when a UE fails to receive or successfully decode all scheduled DCI messages, resulting in a mismatch between the expected and actual UCI payload sizes. This mismatch may be an example of a HARQ-ACK codebook (CB) size mismatch. This issue may be particularly problematic for Type 2 (for example, dynamic) HARQ feedback, where the DAI cannot correct the UCI payload size when the last scheduled DCI is missing (or multiple last scheduled DCIs are missing). The DAI may be effective in scenarios where DCIs are missing in the middle of a sequence (for example, less than four consecutive missing DCIs). Specifically, the DAI allows the UE to infer a number of missing DCIs and insert NACKs (for example, zero-bit values) in place of HARQ-ACK feedback. Still, as discussed, the DAI does not resolve cases where the final DCI is missing. This leads to a discrepancy between a UCI payload transmitted by the UE and a UCI payload expected by the network node.

This UCI payload size mismatch is not an issue for Reed-Muller-coded (RM-coded) UCI transmissions when the number of bits is greater than or equal to three and less than or equal to eleven, because encoding a payload in RM coding produces a same codeword (CW) as encoding a payload that includes one or more zero-padded bits. In such cases, the network may correctly interpret the one or more missing bits as NACKs (zero values) without specifying explicit signaling from the UE.

However, for UCI payloads of one or two bits, particularly when PUCCH Format 0 (PF0) or PUCCH Format 1 (PF1) is used, a size mismatch may lead to a 2-to-1 mapping error, which in turn results in a NACK-to-ACK (N2A) error, where the network node incorrectly decodes a NACK as an ACK, or vice versa, due to sequence mapping issues. This occurs because PUCCH Format 0 maps the UCI payload to a cyclic shift value. For example, a UE may decode a first DCI and fail to decode a second DCI of two scheduled DCI messages. As a result, the UE may transmit UCI with a one-bit payload having a value of “1.” The UE maps the one-bit payload to cyclic shift 6 according to a predefined mapping table in PUCCH Format 0, where the payload determines the cyclic shift of a Zadoff-Chu (ZC) sequence. However, when the network node decodes cyclic shift 6, the network node expects a two-bit UCI payload and assumes that the UE actually transmitted a value of {1,1} (for example, two ACKS) based on the predefined mapping table in PUCCH Format 0. Specifically, for a two-bit UCI payload transmitted in accordance with PUCCH Format 0, cyclic shift 6 maps to a HARQ feedback value of {1,1}. Because the second DCI was never received, the second bit should have been a NACK, but the network instead assumes the feedback was for an ACK, resulting in a NACK-to-ACK error.

To mitigate NACK-to-ACK errors, some conventional solutions swap the sequence mapping for specific payloads. For example, instead of interpreting cyclic shift 6 as {1,1}, the network assumes {1,0}, which ensures that the last bit, which the UE was unaware of, is correctly decoded as a NACK. This approach enables automatic zero-padding, where missing bits in a UCI payload size mismatch are filled with NACKs, preventing errors without specifying additional signaling or retransmission.

However, this approach slightly degrades PUCCH performance in cases where no mismatch occurs due to changes in the minimum Euclidean distance between sequences. In sequence-based PUCCH formats, the Euclidean distance represents how distinguishable two sequences are in the presence of noise or interference. When the distance between adjacent sequences is reduced, the likelihood of misclassification at the network node increases, leading to a higher probability of decoding errors. The cost of implementing this solution is the loss of gray mapping for two-bit HARQ feedback, which may impact PUCCH performance when DCI is not missing.

Various aspects of the present disclosure relate to a generalized sequence-based PUCCH design that enables automatic zero-padding under codebook size mismatch conditions. The disclosed techniques extend prior solutions to support the general case of k-bit UCI transmissions, where 2^{k} sequences are specified to maintain structured mapping. To achieve automatic zero-padding and handling of UCI payload size mismatches, the sequence mapping exhibits a nested property. As a result, when the UCI extends from k bits to k+1 bits, the sequence index selection remains structured and predictable.

Various aspects of the present disclosure further consider different sequence design cases. In some examples, sequence separation is achieved through distinct cyclic shifts, such that sequences are orthogonal in the frequency domain. In other examples, different row or column indices of a discrete Fourier transform (DFT) matrix are used to generate orthogonal sequences in the time domain. In other examples, a hybrid approach combines both frequency domain cyclic shifts and time domain DFT indexing.

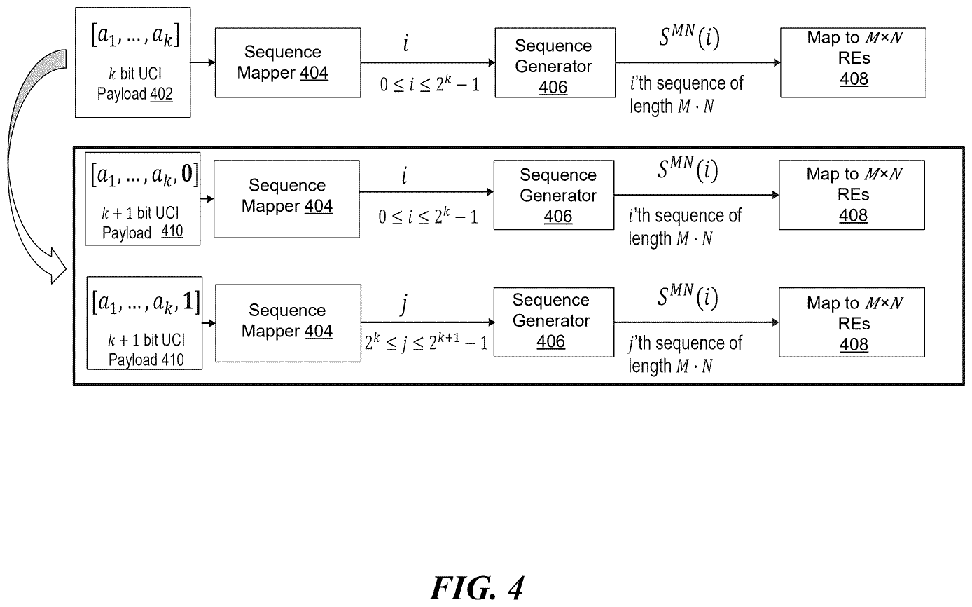

As discussed, a PUCCH sequence design with a nested property may be specified to ensure structured sequence mapping when the UCI is extended from k bits to k+1 bits. FIG. 4 is a block diagram illustrating an example of PUCCH sequence design with a nested property, in accordance with various aspects of the present disclosure. As shown in the example of FIG. 4, a UE may generate a k-bit UCI payload [a₁, . . . , aₖ] 402, which is then processed through a sequence mapper 404. The sequence mapper 404 maps the binary sequence [a₁, . . . , aₖ] of the k-bit UCI payload 402 to a first sequence index i, where the first sequence index i is within a range 0≤i≤2^{k}−1. The first sequence index i may then be used by a sequence generator 406, which generates an i^{th} sequence S^{MN}(i) having a total length M·N. Finally, as shown in the example of FIG. 4, the generated sequence S^{MN}(i) is mapped to resource elements (REs) (block 408) in the frequency-time domain. The number of REs allocated is determined by M (representing the number of frequency domain REs) and N (representing the number of REs in the time domain).

As shown in the example of FIG. 4, the UE may then generate a k+1-bit UCI payload [a₁, . . . , aₖ, aₖ₊₁] 410 sequence index selection follows a structured rule based on the value of the last bit aₖ₊₁. If the last bit aₖ₊₁ of the k+1-bit UCI payload 410 is zero, a sequence index for encoding the k+1-bit UCI payload 410 is the first sequence index i that was used for the original k-bit UCI payload 402. This ensures continuity in sequence mapping. In the example of FIG. 4, the process for generating the sequence S^{MN}(i) and allocating REs for the k+1-bit UCI payload 410 is similar to the process described for the k-bit UCI payload 402.

Alternatively, as shown in the example of FIG. 4, if the last bit aₖ₊₁ of the k+1-bit UCI payload 410 is one, the sequence index for encoding the k+1-bit UCI payload 410 is a second sequence index j, where 2^{k}≤j≤2^{k+1}−1. The second sequence index j is not associated with any k-bit payload. The second sequence index j may then be used by the sequence generator 406, which generates a j^{th} sequence S^{MN}(j) having a total length M·N. Finally, as shown in the example of FIG. 4, the generated sequenc S^{MN}(j) is mapped to REs (block 408) in the frequency-time domain. The number of REs allocated is determined by M and N. This mapping approach differentiates between k-bit and k+1-bit UCI payloads 402 and 410.

In some examples, the sequence index is based on a cyclic shift value m_{CS}, where 0≤m_{CS}≤M−1, the mapping order of the k+1-bit UCI payload [a₁, . . . , aₖ₊₁] to a cyclic shift value follows the decimal representation of the k+1-bit UCI payload [a₁, . . . , aₖ₊₁] relative to a respective decimal representation of one or more other UCI payloads. This mapping inherently ensures the nested property, as UCI payloads with even decimal representations, meaning those with zero as the last bit [a₁, . . . , aₖ, 0], are mapped to the same cyclic shift or sequence index (for example, the first sequence index i) corresponding to the k-bit UCI [a₁, . . . , aₖ]. UCI payloads with odd decimal representations, meaning those with one as the last bit [a₁, . . . , aₖ, 1], are mapped to a different sequence index, such as the second sequence index j.

In some cases, when a total number of cyclic shifts M matches the number of possible UCI payloads 2^{k+1}, the cyclic shift value m_{CS} equals the decimal representation of the k+1-bit UCI payload [a₁, . . . , aₖ₊₁]. In other cases, when the total number of cyclic shifts M is an integer multiple of the number of possible payloads 2^{k+1} (for example, M=a·2^{k+1}) then as a special case (but not as a general rule), the cyclic shift m_{CS} is equal to the decimal representation of the k+1-bit UCI payload [a₁, . . . , aₖ₊₁] multiplied by value a. This structured mapping ensures that nested sequence indexing is preserved, allowing the network node to support automatic zero-padding without additional signaling overhead.

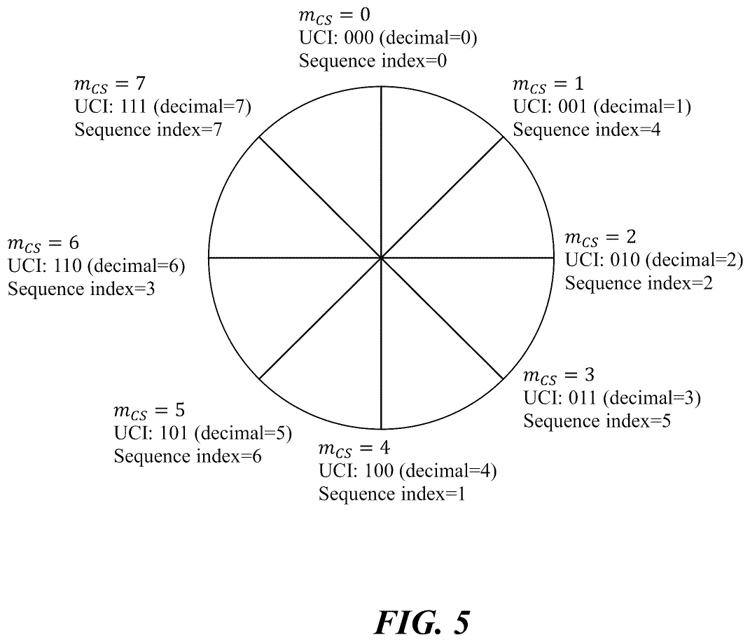

FIG. 5 is a diagram illustrating an example of cyclic shift mapping, in accordance with various aspects of the present disclosure. Specifically, FIG. 5 illustrates an example of how cyclic shift values m_{CS} may be assigned to UCI payloads when the sequence mapping is based on the decimal representation of binary sequences. In this example, the k+1-bit UCI payload is a three-bit payload, and the total number of cyclic shifts M is eight, meaning there are eight possible cyclic shifts, ranging from m_{CS}=0 to m_{CS}=7. Each three-bit UCI payload is mapped to a cyclic shift value equal to its decimal representation.

This mapping ensures the nested property, where UCI payloads with an even decimal representation (for example, those ending in 0) are mapped to the same cyclic shift or sequence index as their corresponding k-bit UCI without the last bit. For example, the UCI payload “000” (decimal 0) is assigned to sequence index 0. Likewise, a two-bit UCI payload “00” (decimal 0) is also assigned to sequence index 0. As another example, the UCI payload “100” (decimal 4) is assigned to sequence index 1. Likewise, a two-bit UCI payload “10” (decimal 4) is also assigned to sequence index 1. However, three-bit UCI payloads ending in one, such as the UCI payload “001” do not map to the same sequence index as the two-bit representation. For example, the UCI payload “001” is assigned to sequence index 4, while the two-bit UCI payload “00” (decimal 0) is assigned to sequence index 0.

FIG. 5 illustrates how the nested sequence indexing property is preserved when extending from the k-bit UCI payload to the k+1-bit UCI payload. As discussed, if the last bit of the k+1-bit UCI payload is removed, the cyclic shifts remain structured, such that the nested indexing is consistent across different UCI payload sizes. This mapping structure remains valid even when the number of cyclic shifts M is an integer multiple of the number of UCI payloads 2^{k+1}, such as in cases where NR uses 12 cyclic shifts. In the example of FIG. 5, the mapping of UCI payloads to cyclic shifts follows a structured order. Specifically, as shown in the example of FIG. 5, starting from cyclic shift index 0 and moving clockwise, each cyclic shift corresponds to a UCI payload whose binary value increases in decimal order. More specifically, the UCI payloads are mapped to cyclic shifts in the same sequence as their decimal representations, from 000 (decimal 0) to 111 (decimal 7). In some examples, the cyclic shift spacing may be non-uniform to specify a larger cyclic shift difference between two neighboring UCI payloads that have a greater number of bit differences in their binary sequences. The non-uniform cyclic shift spacing may improve sequence distinguishability and reduce a likelihood of decoding errors. In cases where a number M of cyclic shifts is greater than a number of UCI payloads to be mapped (for example, when there are 12 cyclic shifts but only 8 UCI payloads to map), the distances between assigned cyclic shifts may not be equal. Instead of evenly distributing cyclic shifts (for example, assigning cyclic shifts at sequence index 3 and sequence index 9), an optimized spacing approach (for example, assigning shifts at sequence index 2 and sequence index 8) increases the separation between UCI payloads that have a greater number of bit differences. The non-uniform mapping causes UCI payloads with smaller differences to remain mapped to closer cyclic shifts, while sequences with larger bit differences are assigned cyclic shifts that are farther apart, improving decoding accuracy and reducing errors.

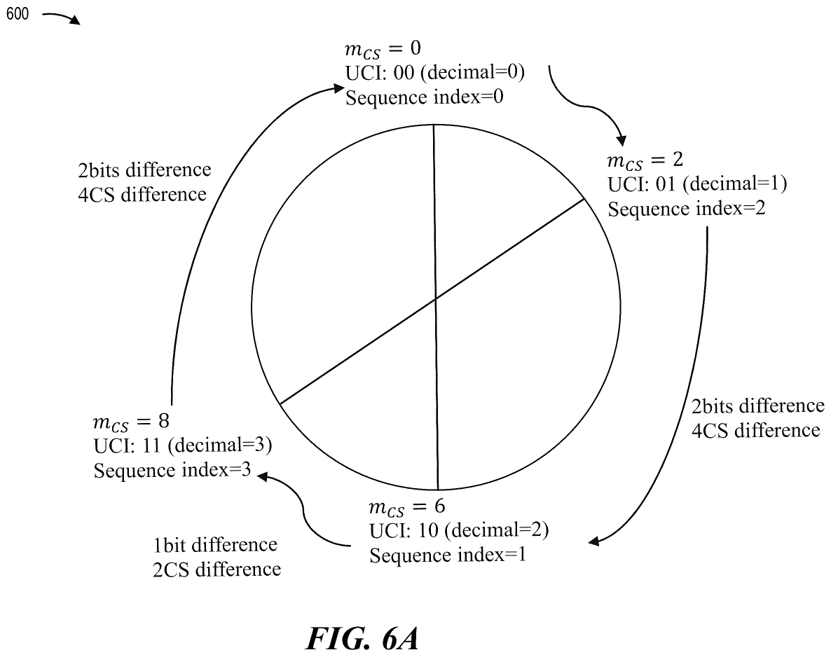

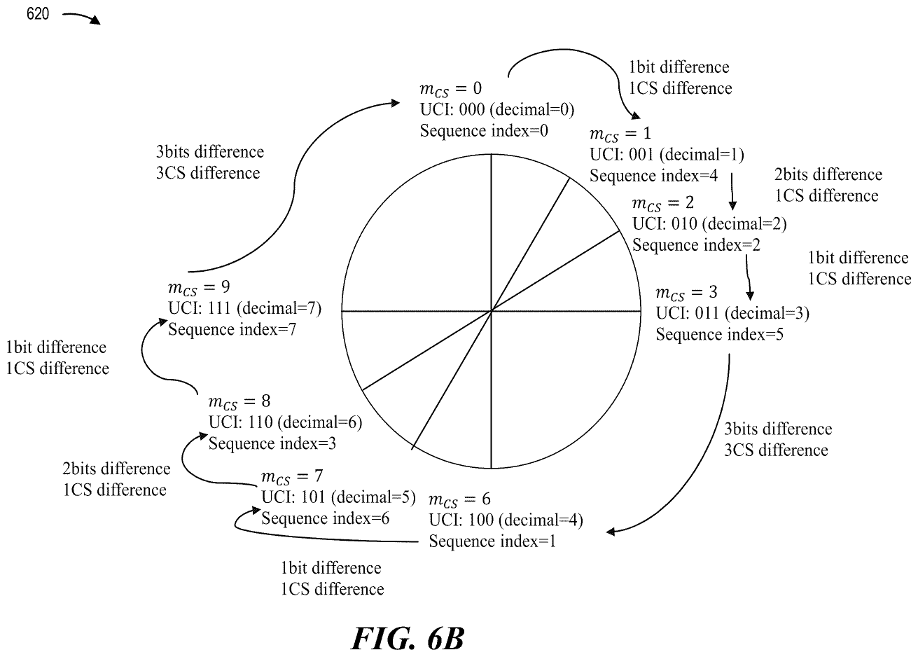

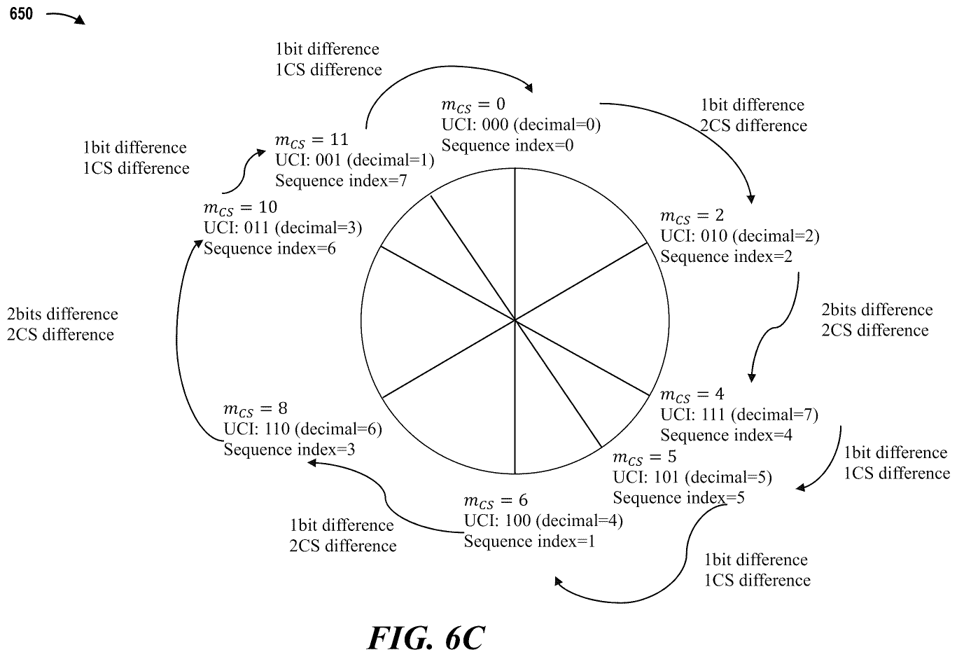

FIG. 6A is a diagram illustrating an example of non-uniform cyclic shift spacing 600, in accordance with various aspects of the present disclosure. In the example of FIG. 6A, the k+1-bit UCI payload is a two-bit payload (for example, k+1=2) and a number of available cyclic shifts is twelve (for example, M=12). For a two-bit UCI payload, four possible UCI payloads (“00”, “01”, “10”, and “11”) may be mapped to different sequence indices. In the example of FIG. 6A, instead of evenly distributing cyclic shifts, the mapping is adjusted to specify that sequences with a higher number of bit differences are mapped further apart in cyclic shift space, while those with fewer bit differences remain closer together.

For example, when two UCI payloads differ by only one bit, they are assigned closer cyclic shifts, with a cyclic shift difference of two. As shown in the example of FIG. 6A, the UCI payload “00” (m_{CS}=0) and the UCI payload “01” (m_{CS}=2) have a single-bit difference and are assigned cyclic shifts only two positions apart. Similarly, the UCI payload “10” (m_{CS}=6) and the UCI payload “11” (m_{CS}=8) also differ by one bit and are separated by a cyclic shift difference of two.

On the other hand, UCI payloads that differ by two bits are spaced further apart, ensuring a cyclic shift separation of four. For example, the UCI payload “00” (m_{CS}=0) and the UCI payload “11” (m_{CS}=8) have a two-bit difference, and their cyclic shifts are four positions apart. The same applies to the UCI payload “01” (m_{CS}=2) and the UCI payload “10” (m_{CS}=6). This non-uniform spacing may preserve the nested property of sequence mapping, meaning that removing a least significant bit (LSB) from a k+1 bits sequence should still map to the same cyclic shift as its k bits counterpart.

FIG. 6B is a diagram illustrating an example of non-uniform cyclic shift spacing 620, in accordance with various aspects of the present disclosure. In the example of FIG. 6B, the k+1-bit UCI payload is a three-bit payload (for example, k+1=3), and the number of available cyclic shifts is twelve (for example, M=12). For a three-bit UCI payload, eight possible UCI payloads (“000”, “001”, “010”, “011”, “100”, “101”, “110”, and “111”) may be mapped to different sequence indices. In the example of FIG. 6B, instead of evenly distributing cyclic shifts, the mapping is adjusted to specify that sequences with a higher number of bit differences are mapped further apart in cyclic shift space, while those with fewer bit differences remain closer together.

For example, when two UCI payloads differ by only one bit, they are assigned closer cyclic shifts, with a cyclic shift difference of one. As shown in the example of FIG. 6B, the UCI payload “000” (m_{CS}=0) and the UCI payload “001” (m_{CS}=1) have a single-bit difference and are assigned cyclic shifts only one position apart. Similarly, the UCI payload “010” (m_{CS}=2) and the UCI payload “011” (m_{CS}=3) also differ by one bit and are separated by a cyclic shift difference of one.

On the other hand, UCI payloads that differ by three bits are spaced further apart than UCI payloads that differ by one bit or two bits. For example, the UCI payload “000” (m_{CS}=0) and the UCI payload “111” (m_{CS}=9) have a three-bit difference, and their cyclic shifts are three positions apart. The same applies to the UCI payload “100” (m_{CS}=6) and the UCI payload “011” (m_{CS}=3).

FIG. 6C is a diagram illustrating an example of non-uniform cyclic shift spacing 650, in accordance with various aspects of the present disclosure. In the example of FIG. 6C, the nested property is preserved, however, the spacing of cyclic shift differs in comparison to the non-uniform cyclic shift spacing 620 described with reference to FIG. 6B. The k+1-bit UCI payload is a three-bit payload (for example, k+1=3), and the number of available cyclic shifts is twelve (for example, M=12). For a three-bit UCI payload, eight possible UCI payloads (“000”, “001”, “010”, “011”, “100”, “101”, “110”, and “111”) may be mapped to different sequence indices. In the example of FIG. 6C, two consecutive cyclic shifts are assigned only to binary sequences that differ by a single bit. Thus, in contrast to the non-uniform cyclic shift spacing 620 described with reference to FIG. 6B, where cyclic shifts were mapped in numerical order based on the decimal representation of the UCI payload, non-uniform cyclic shift spacing 650 shown in FIG. 6C prevents binary sequences with two-bit differences from being assigned to consecutive cyclic shifts.

For example, in the case of UCI payload “000” (m_{CS}=0) and “001” (m_{CS}=11), these payloads differ by only one bit and are assigned cyclic shifts that are consecutive, for example, sequence index 0 and sequence index 7, respectively. Conversely, UCI payloads that differ by two bits, such as “010” (m_{CS}=2) and 111 (m_{CS}=4), are not mapped to consecutive cyclic shifts to reduce the likelihood of sequence misinterpretation due to noise or interference. This approach preserves the structured mapping of nested sequence indexing while ensuring that sequences corresponding to payloads differing by two or more bits are spaced further apart, thereby enhancing the reliability of PUCCH transmission.

In some examples, instead of a cyclic shift value, the sequence index is based on the row or column index n of a size N of a DFT matrix (0≤n≤N−1). The mapping follows the principles described above with respect to the cyclic shift values. However, instead of using a cyclic shift m_{CS} to differentiate sequence index, the row or column index n of the DFT matrix is used as the distinguishing parameter. Consequently, the number of cyclic shifts M is replaced by the size N of the DFT matrix. This mapping provides orthogonalization in the time domain rather than the frequency domain. As noted, the core structure of the nested indexing remains unchanged, rather, cyclic shift values may be interpreted as the difference in row or column indices within the DFT matrix.

In some examples, a sequence index may be based on a cyclic shift value and a row or column index of a DFT matrix (m_{CS}, n). In such examples, for a k-bit UCI payload (k=k₁+k₂, where k₁∧k₂≥1), the UE may map the k₁ bits to the cyclic shift value m_{CS} and k₂ bits to the row or column index n. Additionally, when the UE transmits an extended k+1-bit UCI payload [a₁, . . . , aₖ, aₖ₊₁], the mapping is determined based on a domain (for example, cyclic shift domain or DFT domain) in which the last bit aₖ₊₁ is transmitted.

If the last bit aₖ₊₁ is transmitted in the cyclic shift domain, the UE follows one of the two cases. In one case, if the last bit aₖ₊₁ is zero, the UE retains the same pair (m_{CS}, n) as used for the k-bit UCI. Alternatively, if the last bit aₖ₊₁ is one, the UE selects a new pair (m′_{CS}, n), where the cyclic shift value m′_{CS} is different from any cyclic shift value previously assigned to the k-bit UCI, while the DFT index n is the same as the DFT index n used for the k-bit UCI.

Furthermore, if the last bit aₖ₊₁ is transmitted in the DFT domain, the UE applies a different mapping. In such cases, if the last bit aₖ₊₁ is zero, the UE retains the same pair (m_{CS},n) as used for the k-bit UCI. Alternatively, if the last bit aₖ₊₁ is one, the UE selects a new pair (m_{CS},n′), where the cyclic shift value m_{CS} is the same as the cyclic value m_{CS} used for the k-bit UCI, while the DFT index n′ is different from any DFT index previously assigned to the k-bit UCI. In this approach, the bits mapped to different cyclic shifts may not necessarily be consecutive bits of the UCI, and similarly, the bits mapped to different row or column indices of the DFT matrix may not necessarily be consecutive. In the current examples, a first sequence index i as described with reference to FIG. 4, is determined based on the pair (m_{CS},n) and a second sequence index j may be determined based on a new pair (m_{CS},n′) or (m′_{CS},n).

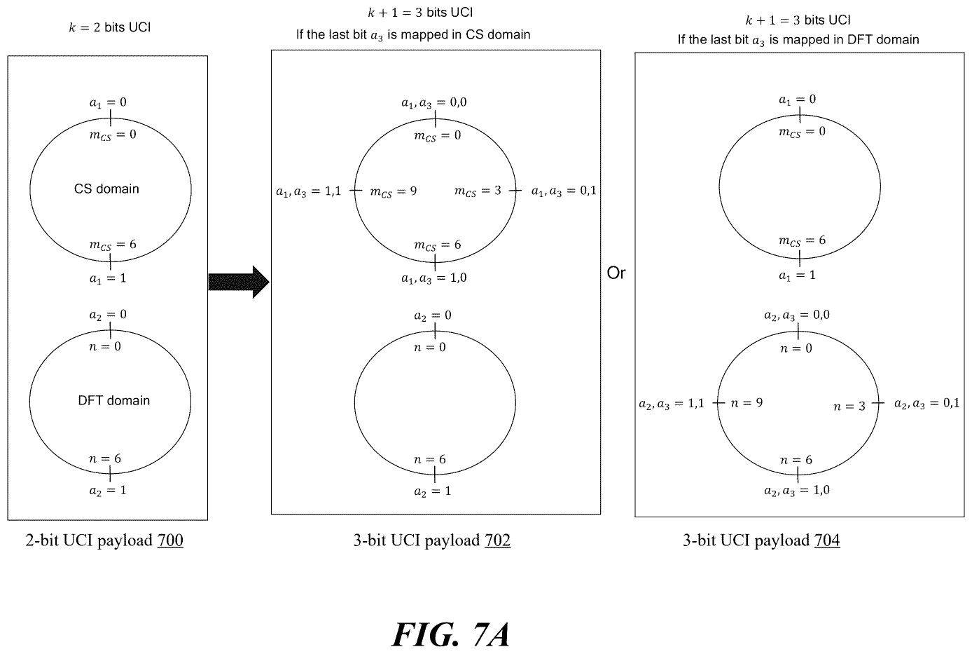

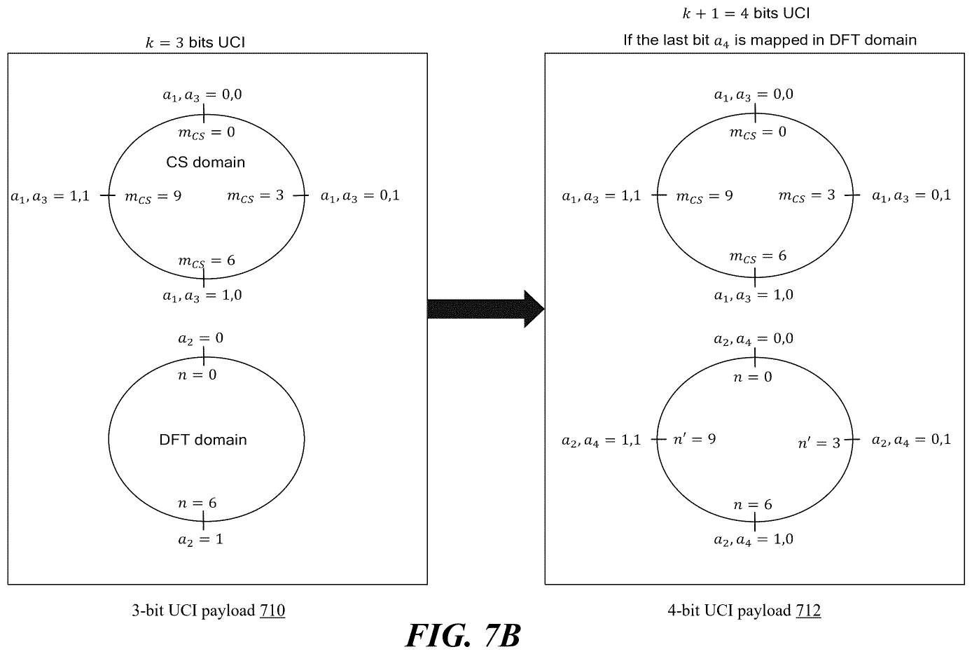

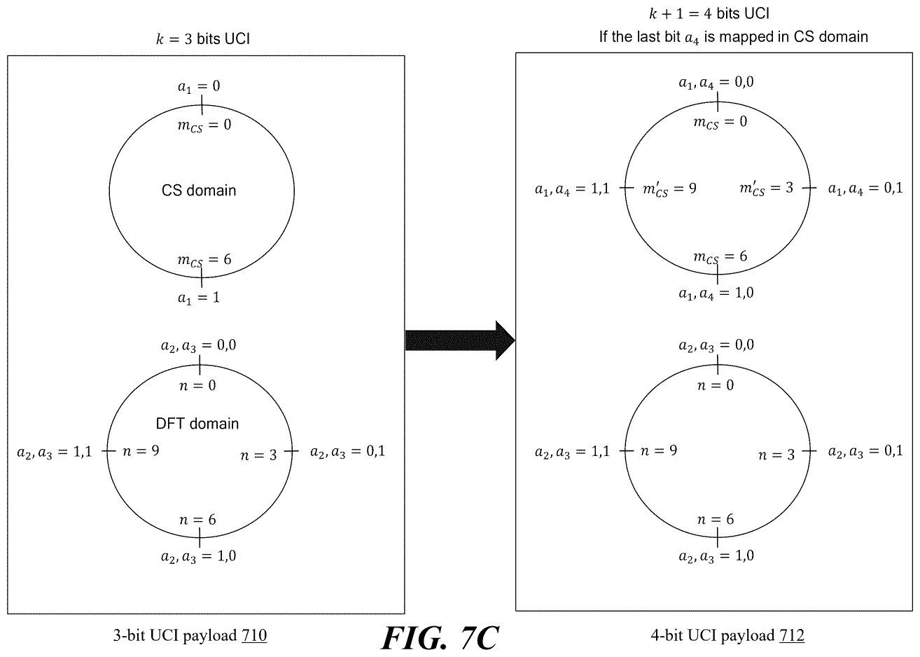

FIG. 7A illustrates an example of sequence mapping based on a cyclic shift value and a row or column index of a DFT matrix, in accordance with various aspects of the present disclosure. FIGS. 7B and 7C illustrate examples of sequence mappings based on a cyclic shift value and a row or column index of a DFT matrix, in accordance with various aspects of the present disclosure. As discussed, the last bit aₖ₊₁ of a k+1-bit UCI payload may be assigned in either the cyclic shift (CS) domain or the DFT domain. FIG. 7A illustrates an example of mapping transitions from a two-bit UCI payload 700 to a three-bit UCI payload 702. In the examples of FIGS. 7A, 7B, and 7C, it is assumed that a total number of cyclic shifts M is twelve and a total number of row or column indices N in the DFT matrix is also twelve. For ease of explanation, a row or column index may be referred to as a row/column index.

In the example of FIG. 7A, the leftmost section represents a mapping of the two-bit UCI payload 700 (a₁, a₂). In this example, the first bit a₁ is mapped to the cyclic shift domain, determining the cyclic shift index m_{CS}, while the second bit a₂ is mapped to the DFT domain, determining the row/column index n of the DFT matrix. As shown in FIG. 7A, if a₁=0, the cyclic shift is assigned as m_{CS}=0, and if a₁=1, the cyclic shift is m_{CS}=6. Similarly, if a₂=0, the row/column index is n=0, and if a₂=1, the row/column index is n=6.

As shown in the example of FIG. 7A, the two-bit UCI payload 700 (for example, k-bit UCI payload) may be expanded to a three-bit UCI payload 702 or 704 (a₁, a₂, a₃) (for example, k+1-bit UCI payload). The middle column (702) of FIG. 7A illustrates an example where the added third bit a₃ is mapped in the cyclic shift domain. In this example, the first and third bits (a₁, a₃) determine the cyclic shift m_{CS}. In some examples, if the final bit a₃=0, the cyclic shift value m_{CS} remains the same as the cyclic shift value m_{CS} mapped to the two-bit UCI payload 700, maintaining the nested property from the two-bit UCI payload 700. However, if the final bit a₃=1, a new cyclic shift value m′_{CS} is assigned to differentiate from previous the mapping of the two-bit UCI payload 700. For example, as shown in FIG. 7A, when a₃=1, the mapping is updated to m′_{CS}=3 or 9 instead of remaining at m_{CS}=0∨6, which corresponds to the two-bit UCI payload 700. Additionally, in such examples, the second bit a₂ maintains the row/column index n mapping of the two-bit UCI payload 700.

The rightmost column (704) represents a scenario where the final bit a₃ is mapped in the DFT domain. Here, the second and third bits (a₂, a₃) determine the row/column index n of the DFT matrix. If the final bit a₃=0, the row/column index n remains unchanged from the two-bit UCI payload 700. However, if the final bit a₃=1, a new row/column index n′ is assigned. For example, when the final bit a₃=1, the mapping is updated, such that the row/column index n′=3 or 99 instead of remaining at n=0 or 6, which corresponds to the two-bit UCI payload 700.

As shown in the example of FIG. 7A, the nested property is preserved, such that removing a last bit of the three-bit UCI payload 704 restores the original mapping from the two-bit UCI payload 700. The approach maintains structure and adaptability, allowing flexible assignment of new bits to either frequency-based (cyclic shift) or time-based (DFT) domains.

FIGS. 7B and 7C illustrate examples of sequence mappings based on a cyclic shift value and a row or column index of a DFT matrix, in accordance with various aspects of the present disclosure. Specifically, FIGS. 7B and 7C illustrate examples of extending a three-bit UCI payload 710 to a four-bit UCI payload 712 while maintaining the nested property in accordance with mapping a final bit a₄ to either the cyclic shift domain or the DFT domain. FIGS. 7B and 7C build upon the example illustrated in FIG. 7A by having the three-bit UCI payload 710 as the baseline and demonstrating how an additional bit is incorporated while preserving the structured mapping.

In the examples of FIGS. 7B and 7C, the left column illustrates an example of mapping bits (a₁, a₂, a₃) of the three-bit UCI payload 710 to cyclic shift values m_{CS} and row/column indices n. In the example of FIG. 7B, the values of the first and third bits (a₁, a₃) of the three-bit UCI payload 710 determine the cyclic shift value m_{CS} and the value of the second bit a₂ determines the row/column index n of the DFT matrix.

In the examples of FIGS. 7B and 7C, the three-bit UCI payload 710 may be expanded to the four-bit UCI payload 712 (a₁, a₂, a₃, a₄). In the example of FIG. 7B, the last bit a₄ of the four-bit UCI payload 712 is mapped to the DFT domain. In this case, the second and fourth bits (a₂, a₄) determine the row/column index n of the DFT matrix, while the cyclic shift mappings for the first and third bits remain the same as the mapping for the three-bit UCI payload 710. As shown in the example of FIG. 7B, if the final bit a₄=0, the row/column index n stays the same as the row/column index n mapped to the three-bit UCI payload 710, maintaining consistency in mapping. However, if the final bit a₄=1, a different row/column index n′ is mapped to the four-bit UCI payload 712 (for example, n′=9∨3), ensuring differentiation from sequences where the final bit a₄=0.

In the example of FIG. 7C, the values of the second and third bits (a₂, a₃) of the three-bit UCI payload 710 determine the row/column index n of the DFT matrix and the value of the first bit a₁ determines the cyclic shift value m_{CS}. For example, if the first bit a₁=0, the cyclic shift value m_{CS}=0, and if the first bit a₁=1, the cyclic shift value m_{CS}=6. Additionally, as shown in the example of FIG. 7C, the last bit a₄ of the four-bit UCI payload 712 is mapped to the cyclic shift domain.

In the example of FIG. 7C, the mapping of the final bit a₄ remains consistent with the mapping of the first bit a₁ of the three-bit UCI payload 710 to the cyclic shift value m_{CS} when a value of the final bit a₄ is zero, ensuring that removing the final bit a₄ still results in the same mapping as in the three-bit UCI payload 710. However, if the value of the final bit a₄ is one, the cyclic shift value is mapped to a different value m′_{CS} (for example, m′_{CS}=3 or 9) than the cyclic shift value m_{CS} of the three-bit UCI payload 710. The DFT domain mapping remains unchanged, as it depends on the second and third bits (a₂, a₃), ensuring the nested property is preserved.

In various aspects of the present disclosure, the network node may explicitly indicate whether a nested sequence should be used for UCI transmissions, such as HARQ feedback transmissions via the physical uplink control channel, or whether a non-nested sequence should be used instead. For example, this decision may follow the structure of existing NR tables to determine the appropriate transmission sequence. In some examples, the determination of whether to use the nested sequence or non-nested sequence may be based on a trade-off between physical uplink control channel performance and robustness to missing DCI messages. Specifically, when there is no codebook size mismatch, improving physical uplink control channel performance may be the primary concern, whereas when a codebook size mismatch occurs, robustness to missing DCIs may be desirable.

In some examples, for cell-edge UEs, where physical uplink control channel performance may be a throughput bottleneck, a non-nested sequence may be desirable. This approach preserves gray mapping, maximizing a Hamming distance between sequences and improving transmission reliability. However, for cell-center or cell-middle UEs, where physical uplink control channel performance is not a limiting factor, the nested sequence structure may be beneficial. In such cases, robustness against missing DCI messages is prioritized, making the nested mapping approach more suitable to handle potential codebook mismatches.

The network node may use an RRC message (semi-static), a MAC-CE message, or a DCI message to indicate whether the UE should apply nested or non-nested sequences. In some examples, the RRC message may directly configure the mapping between 2^{k} possible payloads of length k and their respective sequence indices, cyclic shifts, or DFT mappings for each payload length. This approach provides a high degree of flexibility, allowing the network to dynamically select mapping processes based on specific needs. By configuring the mapping explicitly, the network can either ensure the nested property or adopt other optimizations, such as gray mapping, to maximize the Hamming distance between binary sequences, similar to legacy NR for two-bit cases. This direct configuration method represents an alternative to a recursively defined sequence generation process, allowing for a predefined mapping between UCI payloads and their transmission parameters.

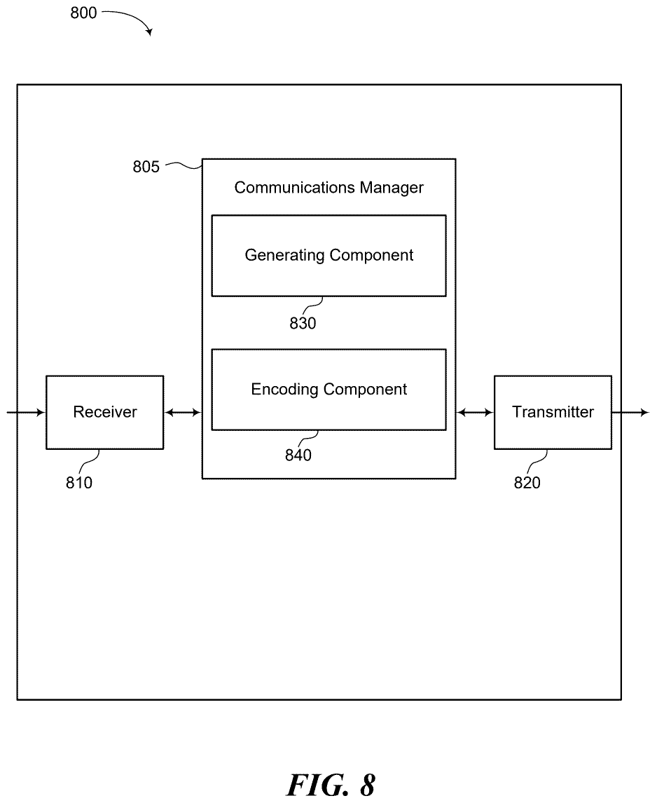

FIG. 8 is a block diagram illustrating an example wireless communication device 800 that supports encoding UCI in accordance with a nested sequence indexing framework, in accordance with various aspects of the present disclosure. The wireless communication device 800 may be an example of aspects of a UE 120 described with reference to FIGS. 1, 2, and 3. The wireless communication device 800 may include a receiver 810, a communications manager 805, a transmitter 820, a generating component 830, and an encoding component 840, which may be in communication with one another (for example, via one or more buses). In some examples, the wireless communication device 800 is configured to perform operations, including operations of the process 900 described below with reference to FIG. 9.

In some examples, the wireless communication device 800 can include a chip, chipset, package, or device that includes at least one processor and at least one modem (for example, a 5G modem or other cellular modem). In some examples, the communications manager 805, or its sub-components, may be separate and distinct components. In some examples, at least some components of the communications manager 805 are implemented at least in part as software stored in a memory. For example, portions of one or more of the components of the communications manager 405 can be implemented as non-transitory code executable by the processor to perform the functions or operations of the respective component.

The receiver 810 may receive one or more of reference signals (for example, periodically configured CSI-RSs, aperiodically configured CSI-RSs, or multi-beam-specific reference signals), synchronization signals (for example, synchronization signal blocks (SSBs)), control information and data information, such as in the form of packets, from one or more other wireless communication devices via various channels including control channels (for example, physical downlink control channel (PDCCH) or physical sidelink control channel (PSCCH) and data channels (for example, physical downlink shared channel (PDSCH) or physical sidelink shared channel (PSSCH)). The other wireless communication devices may include, but are not limited to, a base station 110 described with reference to FIGS. 1 and 2, a DU 330, an RU 340, or a CU 310 described with reference to FIG. 3.

The received information may be passed on to other components of the wireless communication device 800. The receiver 810 may be an example of aspects of the receive processor 258 described with reference to FIG. 2. The receiver 810 may include a set of radio frequency (RF) chains that are coupled with or otherwise utilize a set of antennas (for example, the set of antennas may be an example of aspects of the antennas 252 described with reference to FIG. 2).

The transmitter 820 may transmit signals generated by the communications manager 805 or other components of the wireless communication device 800. In some examples, the transmitter 820 may be collocated with the receiver 810 in a transceiver. The transmitter 820 may be an example of aspects of the transmit processor 284 described with reference to FIG. 2. The transmitter 820 may be coupled with or otherwise utilize a set of antennas (for example, the set of antennas may be an example of aspects of the antennas 252 described with reference to FIG. 2), which may be antenna elements shared with the receiver 810. In some examples, the transmitter 820 is configured to transmit control information in a PUCCH, PSCCH, or PDCCH and data in a physical uplink shared channel (PUSCH), PSSCH, or PDSCH.

The communications manager 805 may be an example of aspects of the controller/processor 280 described with reference to FIG. 2. The communications manager 805 may include the generating component 830 and the encoding component 840. In some examples, the generating component 830 may generate first UCI. Additionally, working in conjunction with the generating component 830, the encoding component 840 may encode a first sequence of k+1 bits of first uplink control information (UCI) using a sequence index that is in accordance with a value of a final (k+1)^{th} bit of the first sequence of k+1 bits of the first UCI, the sequence index being: a first sequence index, that is associated with encoding a first k bits of the first sequence of k+1 bits of the first UCI, in accordance with the final (k+1)^{th} bit of the UCI having a first value, or a second sequence index, that is not associated with encoding any sequence of k bits of UCI, in accordance with the final (k+1)^{th} bit of the first UCI having a second value. Furthermore, working in conjunction with the encoding component 840, the transmitter 820 may transmit, to a network node, the encoded UCI.

FIG. 9 is a flow diagram illustrating an example of a process 900 for encoding UCI in accordance with a nested sequence indexing framework, in accordance with various aspects of the present disclosure. The process 900 may be performed by a UE such as a UE 120 described with reference to FIGS. 1, 2, and 3. The process 900 begins at block 902 by encoding a first sequence of k+1 bits of first uplink control information (UCI) using a sequence index that is in accordance with a value of a final (k+1)^{th} bit of the first sequence of k+1 bits of the first UCI, the sequence index being: a first sequence index, that is associated with encoding a first k bits of the first sequence of k+1 bits of the first UCI, in accordance with the final (k+1)^{th} bit of the UCI having a first value, or a second sequence index, that is not associated with encoding any sequence of k bits of UCI, in accordance with the final (k+1)^{th} bit of the first UCI having a second value. At block 904, the process 900 transmits, to a network node, the encoded UCI.

Implementation examples are described in the following numbered clauses:
Clause 1. A method for wireless communication by a user equipment (UE), comprising: encoding a first sequence of k+1 bits of first uplink control information (UCI) using a sequence index that is in accordance with a value of a final (k+1)^{th} bit of the first sequence of k+1 bits of the first UCI, the sequence index being: a first sequence index, that is associated with encoding a first k bits of the first sequence of k+1 bits of the first UCI, in accordance with the final (k+1)^{th} bit of the UCI having a first value, or a second sequence index, that is not associated with encoding any sequence of k bits of UCI, in accordance with the final (k+1)^{th} bit of the first UCI having a second value; and transmitting, to a network node, the encoded UCI.
Clause 2. The method of claim 1, wherein: the sequence index is associated with a first decimal representation of the first sequence of k+1 bits relative to a respective second decimal representation of one or more second sequence of k+1 bits; and each second sequence of k+1 bits of the one or more second sequence of k+1 bits is associated with a respective second UCI.
Clause 3. The method of Clause 2, wherein: the first sequence index corresponds to the first decimal representation being an even number; and the second sequence index corresponds to the first decimal representation being an odd number.
Clause 4. The method of Clause 3, wherein each of the first sequence index and the second sequence index corresponds to a respective cyclic shift value.
Clause 5. The method of Clause 4, wherein cyclic shift spacing is non-uniform.
Clause 6. The method of Clause 3, wherein: the first sequence index is associated with a first row or column index value corresponding to a discrete Fourier transform (DFT) matrix; and the second sequence index is associated with a second row or column index value corresponding to the DFT matrix.
Clause 7. The method of Clause 6, wherein a row or column index spacing is non-uniform.
Clause 8. The method of Clause 1, wherein: each one of the first sequence index and the second sequence index is associated with a respective sequence index pair comprising a cyclic shift value and a row or column index value of a discrete Fourier transform (DFT) matrix; and the final (k+1)^{th} bit of the encoded UCI is transmitted in either a cyclic shift domain or a DFT domain in accordance with each one of the respective sequence index pair.
Clause 9. The method of Clause 8, further comprising determining a second sequence index pair of the second sequence index in accordance with the final (k+1)^{th} bit being transmitted in the cyclic shift domain or the DFT domain and the final (k+1)^{th} bit having the first binary value or the second binary value, wherein: the cyclic shift value and the row or column index value of the second sequence index pair are the same as the cyclic shift value and the row or column index value of a first sequence index pair of the first sequence index in accordance with the final (k+1)^{th} bit having the first binary value; the cyclic shift value of the second sequence index pair is different than any cyclic shift value used for the first sequence index and the row or column index value of the second sequence index pair is the same as the row or column index value of the first sequence index pair in accordance with: the final (k+1)^{th} bit having the second binary value; and the final (k+1)^{th} bit being transmitted in the cyclic shift domain; and the row or column index value of the second sequence index pair is different than any row or column index value used for the first sequence index and cyclic shift value of the second sequence index pair is the same as cyclic shift value of the first sequence index pair in accordance with: the final (k+1)^{th} bit having the second binary value; and the final (k+1)^{th} bit being transmitted in the DFT domain.
Clause 10. The method of any one of Clauses 1-9, further comprising receiving, from the network node, a message indicating that the final (k+1)^{th} bit of the encoded UCI determines a mapping of the sequence index to the first sequence index or the second sequence index.
Clause 11. The method of Clause 10, wherein the message is a radio resource control (RRC) message, a medium access control (MAC-CE) message, or a downlink control information (DCI) message.
Clause 12. The method of any one of Clauses 1-11, wherein the first binary value is zero and the second binary value is one.
Clause 13. The method of any one of Clauses 1-12, wherein the first UCI includes hybrid automatic repeat request (HARQ) feedback.
Clause 14. The method of any one of Clauses 1-13, wherein the first sequence index is the same as a third sequence index for encoding a second UCI associated with a second sequence of k bits.
Clause 15. An apparatus comprising a processor, memory coupled with the processor, and instructions stored in the memory and operable, when executed by the processor to cause the apparatus to perform any one of Clauses 1-14.
Clause 16. An apparatus comprising at least one means for performing any one of Clauses 1-14.
Clause 17. A non-transitory computer-readable medium comprising program code for causing an apparatus to perform any one of Clauses 1-14.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example, related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication by a user equipment (UE), comprising:
encoding a first sequence of k+1 bits of first uplink control information (UCI) using a sequence index that is in accordance with a value of a final (k+1)^{th} bit of the first sequence of k+1 bits of the first UCI, the sequence index being:
a first sequence index, that is associated with encoding a first k bits of the first sequence of k+1 bits of the first UCI, in accordance with the final (k+1)^{th} bit of the UCI having a first value, or
a second sequence index, that is not associated with encoding any sequence of k bits of UCI, in accordance with the final (k+1)^{th} bit of the first UCI having a second value; and
transmitting, to a network node, the encoded UCI.

2. The method of claim 1, wherein:
the sequence index is associated with a first decimal representation of the first sequence of k+1 bits relative to a respective second decimal representation of one or more second sequence of k+1 bits; and
each second sequence of k+1 bits of the one or more second sequence of k+1 bits is associated with a respective second UCI.

3. The method of claim 2, wherein:
the first sequence index corresponds to the first decimal representation being an even number; and
the second sequence index corresponds to the first decimal representation being an odd number.

4. The method of claim 3, wherein each of the first sequence index and the second sequence index corresponds to a respective cyclic shift value.

5. The method of claim 4, wherein cyclic shift spacing is non-uniform.

6. The method of claim 3, wherein:
the first sequence index is associated with a first row or column index value corresponding to a discrete Fourier transform (DFT) matrix; and
the second sequence index is associated with a second row or column index value corresponding to the DFT matrix.

7. The method of claim 6, wherein a row or column index spacing is non-uniform.

8. The method of claim 1, wherein:
each one of the first sequence index and the second sequence index is associated with a respective sequence index pair comprising a cyclic shift value and a row or column index value of a discrete Fourier transform (DFT) matrix; and
the final (k+1)^{th} bit of the encoded UCI is transmitted in either a cyclic shift domain or a DFT domain in accordance with each one of the respective sequence index pair.

9. The method of claim 8, further comprising determining a second sequence index pair of the second sequence index in accordance with the final (k+1)^{th} bit being transmitted in the cyclic shift domain or the DFT domain and the final (k+1)^{th} bit having the first binary value or the second binary value, wherein:
the cyclic shift value and the row or column index value of the second sequence index pair are the same as the cyclic shift value and the row or column index value of a first sequence index pair of the first sequence index in accordance with the final (k+1)^{th} bit having the first binary value;
the cyclic shift value of the second sequence index pair is different than any cyclic shift value used for the first sequence index and the row or column index value of the second sequence index pair is the same as the row or column index value of the first sequence index pair in accordance with:
the final (k+1)^{th} bit having the second binary value; and
the final (k+1)^{th} bit being transmitted in the cyclic shift domain; and
the row or column index value of the second sequence index pair is different than any row or column index value used for the first sequence index and cyclic shift value of the second sequence index pair is the same as cyclic shift value of the first sequence index pair in accordance with:
the final (k+1)^{th} bit having the second binary value; and
the final (k+1)^{th} bit being transmitted in the DFT domain.

10. The method of claim 1, further comprising receiving, from the network node, a message indicating that the final (k+1)^{th} bit of the encoded UCI determines a mapping of the sequence index to the first sequence index or the second sequence index, wherein the message is a radio resource control (RRC) message, a medium access control (MAC-CE) message, or a downlink control information (DCI) message.

11. The method of claim 1, wherein the first binary value is zero and the second binary value is one.

12. The method of claim 1, wherein the first UCI includes hybrid automatic repeat request (HARQ) feedback.

13. The method of claim 1, wherein the first sequence index is the same as a third sequence index for encoding a second UCI associated with a second sequence of k bits.

14. A user equipment (UE) comprising:
one or more processors; and
one or more memories coupled with the one or more processors and storing processor-executable code that, when executed by the one or more processors, is configured to cause the UE to:
encode a first sequence of k+1 bits of first uplink control information (UCI) using a sequence index that is in accordance with a value of a final (k+1)^{th} bit of the first sequence of k+1 bits of the first UCI, the sequence index being:
a first sequence index, that is associated with encoding a first k bits of the first sequence of k+1 bits of the first UCI, in accordance with the final (k+1)^{th} bit of the UCI having a first value, or
a second sequence index, that is not associated with encoding any sequence of k bits of UCI, in accordance with the final (k+1)^{th} bit of the first UCI having a second value; and
transmit, to a network node, the encoded UCI.

15. The UE of claim 14, wherein:
the sequence index is associated with a first decimal representation of the first sequence of k+1 bits relative to a respective second decimal representation of one or more second sequence of k+1 bits; and
each second sequence of k+1 bits of the one or more second sequence of k+1 bits is associated with a respective second UCI.

16. The UE of claim 15, wherein:
the first sequence index corresponds to the first decimal representation being an even number; and
the second sequence index corresponds to the first decimal representation being an odd number.

17. The UE of claim 16, wherein each of the first sequence index and the second sequence index corresponds to a respective cyclic shift value.

18. The UE of claim 16, wherein:
the first sequence index is associated with a first row or column index value corresponding to a discrete Fourier transform (DFT) matrix; and
the second sequence index is associated with a second row or column index value corresponding to the DFT matrix.

19. The UE of claim 14, wherein:
each one of the first sequence index and the second sequence index is associated with a respective sequence index pair comprising a cyclic shift value and a row or column index value of a discrete Fourier transform (DFT) matrix; and
the final (k+1)^{th} bit of the encoded UCI is transmitted in either a cyclic shift domain or a DFT domain in accordance with each one of the respective sequence index pair.

20. A non-transitory computer-readable medium having program code recorded thereon for wireless communication by a user equipment (UE), the program code executed by one or more processors and comprising:
program code to encode a first sequence of k+1 bits of first uplink control information (UCI) using a sequence index that is in accordance with a value of a final (k+1)^{th} bit of the first sequence of k+1 bits of the first UCI, the sequence index being:
a first sequence index, that is associated with encoding a first k bits of the first sequence of k+1 bits of the first UCI, in accordance with the final (k+1)^{th} bit of the UCI having a first value, or
a second sequence index, that is not associated with encoding any sequence of k bits of UCI, in accordance with the final (k+1)^{th} bit of the first UCI having a second value; and
program code to transmit, to a network node, the encoded UCI.
